(19) United States
(12) Patent Application Publication
(10) Pub. No.: US 2014/0106200 A1
(43) Pub. Date: Apr. 17, 2014

(54) High Conductivity Battery Contact

(71) Applicant: Neal Saiki, Santa Cruz, CA (US)

(72) Inventor: Neal Saiki, Santa Cruz, CA (US)

(21) Appl. No.: 14/138,469

(22) Filed: Dec. 23, 2013

Related U.S. Application Data
(63) Continuation-in-part of application No. 13/368,343, filed on Feb. 8, 2012.

(51) Int. Cl. H01M 2/22

(52) U.S. Cl. CPC H01M 2/22
USPC 429/121

(57) ABSTRACT

The present invention is directed to a battery contact for providing electrical contact between a battery cell and a circuit board. Such contact may include: a tab made at least in part from an electrically conductive material, formed with: a mounting section to provide an electrical connection to the circuit board; a flexible section; and a contact section; and a compressive spring configured to push the contact section away from the mounting section and against an end of a battery cell. The contact may be made at least in part from a strip of an conductive material having two ends, and the contact section may include the two ends of the strip with a gap there-between. The contact may be configured to prevent distortion or warping during a soldering or welding process. For example, the mounting section may be configured with a convex curve.

### RELATED APPLICATIONS

This application is a continuation-in-part of U.S. patent application Ser. No. 13/368,343, filed on Feb. 8, 2012, entitled “High Conductivity Battery Contact,” which is incorporated herein by reference in its entirety.

### FIELD OF THE INVENTION

In general, the present invention is directed to the construction of a robust, high conductivity, inexpensive, and easy to assemble and servicable battery contact for battery cells. More specifically, the present invention is directed to battery contact comprising a thin flat, and highly electrically conductive metal configured to be attached to a circuit board. The high conductivity battery contacts may allow for the utilization of high energy density battery cells, such as but not limited to lithium ion cylindrical cells that may be used in high power applications. Such battery packs have numerous applications such as electric tools, energy storage and electric vehicles.

### BACKGROUND

Recent advances in batteries based on lithium chemistries have led to the development of small batteries with extremely high energy density. Unfortunately, the size of these batteries is severely limited due to inherent thermal stability problems. The safest and most common lithium based batteries are the lithium ion cells which are available in a small cylindrical form. Accordingly, battery contacts that may permit the use of one or more cylindrical lithium ion battery cells (and other types of batteries, as well), are desirable.

There are many devices, including for example, electric vehicles that require large stores of energy for electrical power. To address these needs, conventional approaches create a battery pack out of many individual smaller cells and electrically connect them in both series and parallel. This configuration typically produces a desired combination of output voltage and current. In many configurations using this approach, hundreds or thousands of cells may need to be connected together in order to achieve the desired combination of capacity, output voltage and current. This task of assembling large quantities of cells together in a robust and economical way is not adequately solved by conventional assembly methods known in the art. Accordingly, battery contacts that permit larger battery units to be easily and efficiently assembled from multiple battery cells is also desirable.

Manufacturing battery cell assemblies requires significant care and precision in order to create a viable product. For example, cells are typically electrically connected to each other through the use of permanent cell tabs. Such cell tabs may be typically made from thin strips of nickel or stainless steel. The cell tabs are connected to each cell by either spot welding or soldering. The cell tabs must be thin enough to weld to the cell without damaging the cell from excessive welding or soldering heat. In addition, most battery cells, particularly those based on lithium chemistry, are very intolerant of heating. Overheating these types of cells may damage the cell chemistry, resulting in reduced cell capacity to store energy or premature cell failure.

In addition, maintenance of battery packs using existing battery contact tabs may be difficult. A battery pack assembled with all welded construction may not be easily dissembled in order to replace a cell. It may also be difficult to assemble large clusters of cells that have been welded together due to their weight, bulk, and/or fragile connections. Accordingly, connections to battery cells that do not require soldering or other potentially harmful connectivity methods are desirable.

When only low conductivity battery contacts are required, there are numerous designs that utilize steel or steel alloy springs for the contacts. For example, low conductivity batter contacts may be found in the prior in devices such as flashlights. However, while functionality and serviceability of such low conductivity contacts may be acceptable, such designs cannot handle high or higher current. Many devices that require battery cells—such as but not limited to electric vehicles, may require large amounts of peak current. Accordingly, each cell tab must be large enough to carry a heavy current load. Nickel alloy is typically used, yet is only one fifth the conductivity of copper. Therefore, a tab made of nickel alloy may be significantly larger than a copper tab in order to provide equivalent resistance. However, large tabs may be difficult to weld or solder to battery cells without damaging either the battery cell. Moreover, in general the larger the tab the stiffer the tab. Stiff tabs may present reliability problems as such stiffness may not allow for minute cell movement that may occur during thermal expansion or vibration. Accordingly, flexible battery tabs or contacts that provide appropriate resistance are desirable.

In addition, battery tabs or contacts may be difficult to attach to other components, such as but not limited to circuit boards. Distortion or warping of the battery tabs or contacts may occur when such tabs or contacts are soldered to circuit boards, components, etc. Such distortion or warping may prevent consistent and electrically communicative contact between the tab or contact and the component (such as a circuit board), as well as between the tab or contact and the battery cell.

Placement of auxiliary components such as fuses, temperature sensors and temperature cutoffs may also present issues. In general, battery packs as known in the art are covered with complex runs of electrical wires including such auxiliary components. Because of the complexity of the batteries coupled with the auxiliary components, individual battery cells (or groups of battery cells) may be difficult to remove for service or install. Accordingly, battery contacts that may require less auxiliary components—or allow for auxiliary components to be located in positions that do not prevent the efficient removal and service of the battery pack or individual cells is desirable.

### SUMMARY OF THE INVENTION

In accordance with some embodiments of the present invention, aspects may include a battery contact for providing electrical contact between one or more battery cells and a printed circuit board, the battery contact comprising: a tab made at least in part from an electrically conductive material, comprising: a mounting section configured to provide an electrical connection to the printed circuit board; at least one flexible section; and a contact section having an outward facing surface; and a compressive spring configured to push the contact section away from the mounting section, and against an end of a cylindrical battery cell when installed.

In accordance with some embodiments of the present invention, aspects may also include a battery contact for providing electrical contact between one or more battery cells and a printed circuit board, the battery contact comprising: a tab made at least in part from a strip of an electrically conductive material the strip having two ends, comprising: a mounting section configured with a convex curvature away from the printed circuit board, and to provide an electrical connection to the printed circuit board; at least one flexible section; and a contact section comprising the two ends of the strip of material with a gap there-between; and a compressive element disposed between the contact section and the mounting section, the compressive element configured to force the contact section into electrical communication with an end of a battery cell.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary battery contact used with a battery cell and a printed circuit board, in accordance with some embodiments of the present invention.

FIG. 1A illustrates a section view of an exemplary battery contact in accordance with some embodiments of the present invention.

FIG. 2 depicts multiple exemplary battery contacts in a battery module in accordance with some embodiments of the present invention.

FIG. 3 depicts an exemplary battery contact and a compressive element, in accordance with some embodiments of the present invention.

FIG. 4 illustrates an exemplary battery contact, in accordance with some embodiments of the present invention.

FIG. 5 depicts an exemplary battery contact, in accordance with some embodiments of the present invention.

FIG. 6 illustrates an exemplary battery contact in accordance with some embodiments of the present invention.

FIG. 7 illustrates an exemplary battery contact in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In order to address the deficiencies and drawbacks of battery contacts in the prior art, the present invention seeks to: utilize high conductivity metal, such as but not limited to, copper or silver for low electrical resistance; be vibration resistant and reliable; provide connectivity to battery cells that does not require the battery cells to be exposed to heat from soldering or welding; provide battery contacts for which battery cells may be efficiently accessed for service or replacement of individual battery cells from a larger pack; utilize a printed circuit board to provide structural support of the assembly and to provide interconnections between various battery cells, thereby allowing for complex and high current routing, as well as a convenient location upon which to mount auxiliary components.

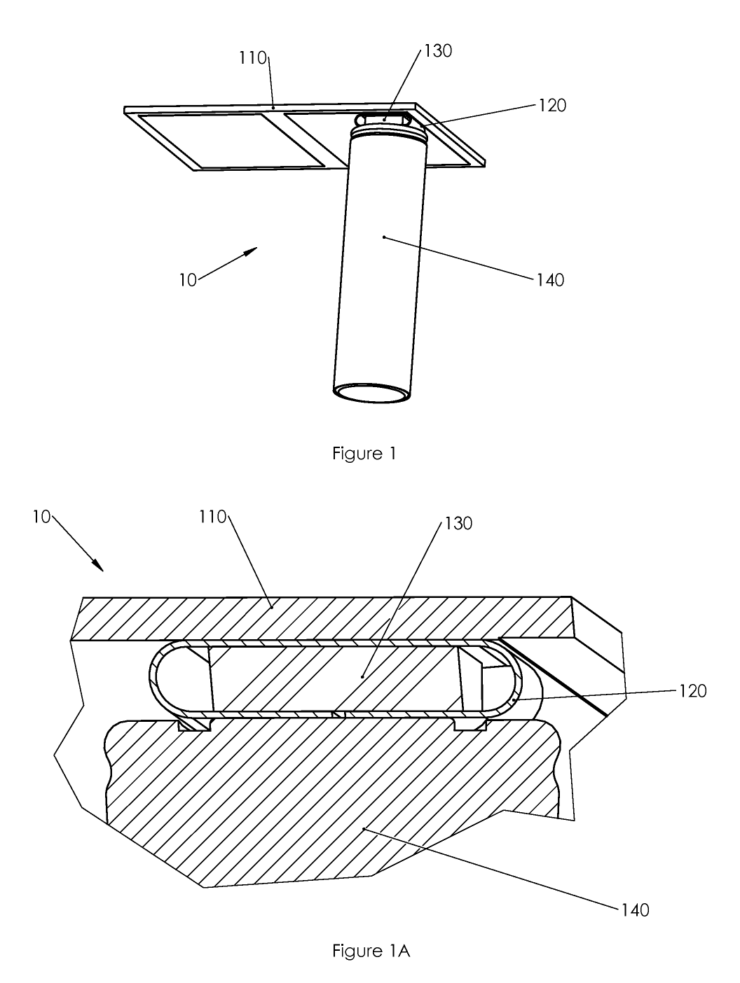

With respect to FIGS. 1 and 1A, an exemplary high conductivity battery contact used with a battery cell and a printed circuit board will now be discussed. A printed circuit board 110 may be a generally planar surface containing dielectric materials for a substrate and conductive electrical pathways, tracks or signal traces containing conductive metal. It is possible to have numerous combinations of dielectric materials and electrical pathways. In accordance with some embodiments of the present invention, a printed circuit board (PCB) similar to ones commonly used in electronics may be used. In general, a PCB 110 may be easy to manufacture and may be available for a low cost. Manufacturing of the conductive pathways is typically accomplished by etching or depositing of metal, but other methods are possible. The conductive traces may be on the exterior faces or contained within interior layers. This ability to have multiple layers of conductive pathways that are electrically isolated allows complex electrical routing on the PCB 110. Conductive pathways may cross each other on different layers and remain isolated. The use of a PCB 110 may also allow for the integration of additional circuits such as temperature monitoring, fuses, circuit breakers, voltage monitoring, current monitoring, etc.

Some possible dielectric materials used in a PCB are polytetrafluoroethylene (Teflon), FR-4, FR-1, CEM-1 or CEM-3. Many printed circuit boards are laminated together with epoxy resin prepreg. Well known prepreg materials used in the PCB industry may include FR-2 (Phenolic cotton paper), FR-3 (Cotton paper and epoxy), FR-4 (Woven glass and epoxy), FR-5 (Woven glass and epoxy), FR-6 (Matte glass and polyester), G-10 (Woven glass and epoxy), CEM-1 (Cotton paper and epoxy), CEM-2 (Cotton paper and epoxy), CEM-3 (Woven glass and epoxy), CEM-4 (Woven glass and epoxy), CEM-5 (Woven glass and polyester). FR-4 is a very common PCB material and provides significant structural strength.

The thickness of a PCB 110 may be on the order of 0.031 to 0.125 inches, although it is contemplated that PCBs that are thicker or thinner may be used without deviating from the invention. Thicker boards can provide more structural resistance to deformation. The PCB 110 may not only hold the conductive pathways, but may also provide structural support for a battery assembly. For example, a PCB made from FR-4 in the thickness of 0.125 inches may be sufficiently rigid and strong enough to support multiple cell assemblies. The PCB 110 may function as a very strong inner wall in a larger pack assembly that may have double or triple exterior walls.

The electrical pathways of a PCB 110 may be generally made from copper, but other conductive materials such as tin, silver, gold or aluminum may be used alone, in combination alloys or as plating materials. Electrical pathways may be bonded on the face of the PCB 110.

A tab 120 may be electrically connected to the electrical pathways on the PCB 110. Tab 120 may be formed from or comprise, at least in part, copper or other high conductivity metals. It is contemplated that tabs (for example, those made of copper) may be plated to prevent corrosion. Materials such as tin, gold, or silver may be used alone or in combination for plating materials. The exemplary tab 120 shown in FIGS. 1 and 1A in profile view may be substantially in the shape of an oval or a racetrack: a hollow shape with two flat sides with rounded semi-circular ends connecting each flat side. One flat side may be formed by the overlapping ends of the strip. Alternatively, there may be a gap in the oval or racetrack shape, where the ends of the strip do not reach each other. The overlap or gap may be located on the side of the tab 120 proximate to the PBC 110, or may be on the side of the tab proximate to the battery cell 140. The other flat side is approximately midway between the ends. There may be a bend radius at each semi-circular bend to form a parallel gap in middle of the section.

An elastomeric pad 130 may be located inside of the tab hollow space. The pad comprises elastomeric material so as to have the quality of being compressible and preferably with minimal compression set. Additional material qualities such as high temperature resistance and resistance to aging are also desirable. Materials such as those comprising silicone in either solid or foam structure are suitable. Silicone foam comes in either open or closed cell structure.

The elastomeric pad 130 may be with any number of compressive springs that would function equivalently. Some examples are: conventional wire coil springs, disc springs, wave disc springs, composite leaf springs or air springs. Since the tab 120 may provide a conductive pathway, the elastomeric pad 130 or compressive spring does not need to be highly conductive.

It is also contemplated that the elastomeric pad 130 may comprise a spring element in a compressed position, so as to provide a force against the sides of the tab 120.

The elastomeric pad 130 may have a thickness that fills or substantially fills the inside of the tab 120 cavity. Alternatively, the elastomeric pad 130 may be smaller than the cavity of the tab 120, and may be positioned to provide an expansion force on a particular part or portion of the tab 120.

The length and width of the elastomeric pad 130 may be approximately within the area of the flat end of the tab. The elastomeric pad 130 may be in any shape or size. For examples the elastomeric pad 130 may be circular or square, may comprise a long strip that bridges multiple cells, a dome shape or a pyramid shape. A tapered or stepped shape that has variable cross section area may provide non-linear force. Such non-linear force may be useful to limit the maximum compression of the elastomeric pad during mechanical shock. Mechanical shock can occur from dropping the battery pack or from a vehicle collision. Also the pad may be made from multiple parts or multiple materials. Additional structure may be added to limit maximum compression of the elastomeric pad during mechanical shock.

Regardless of the specific shape of the elastomeric pad 130, at least a portion of the elastomeric pad 130 may be disposed under at least a portion of the flat end section of the tab 120.

The elastomeric pad 130 may or may not be mechanically held in position. During assembly or disassembly, the elastomeric pad 130 may shift out of position, so some additional means of securing may be utilized. Some examples of securing means may include adhesive or small features on the tab 120 to retain the elastomeric pad 130. For example, the tab 120 may comprise smaller tabs or protrusions oriented to retain the elastomeric pad 130 in the proper position. Additionally, the elastomeric pad 130 may be molded with small features to secure around the pad 130 around features or edges of the tab 120.

A cylindrical battery cell 4 is shown to illustrate the positioning of the battery cell 140 relative to the rest of the assembly. Cylindrical battery cells 140 are common forms for battery cells, though the contacts disclosed by and claimed by the present invention are equally applicable to battery cells of any shape or size. With reference to cylindrical battery cell 140, one portion of the cell 140 may be electrically charged with one polarity and another portion charged in the opposite polarity. In the case of cylindrical batteries, some ends may terminate a smaller raised circular area sometimes referred to as a button that may be electrically charged with one polarity. The battery cell 140 may be oriented so that one of the charged end surfaces is pressed in contact with the outer flat section of the tab 120.

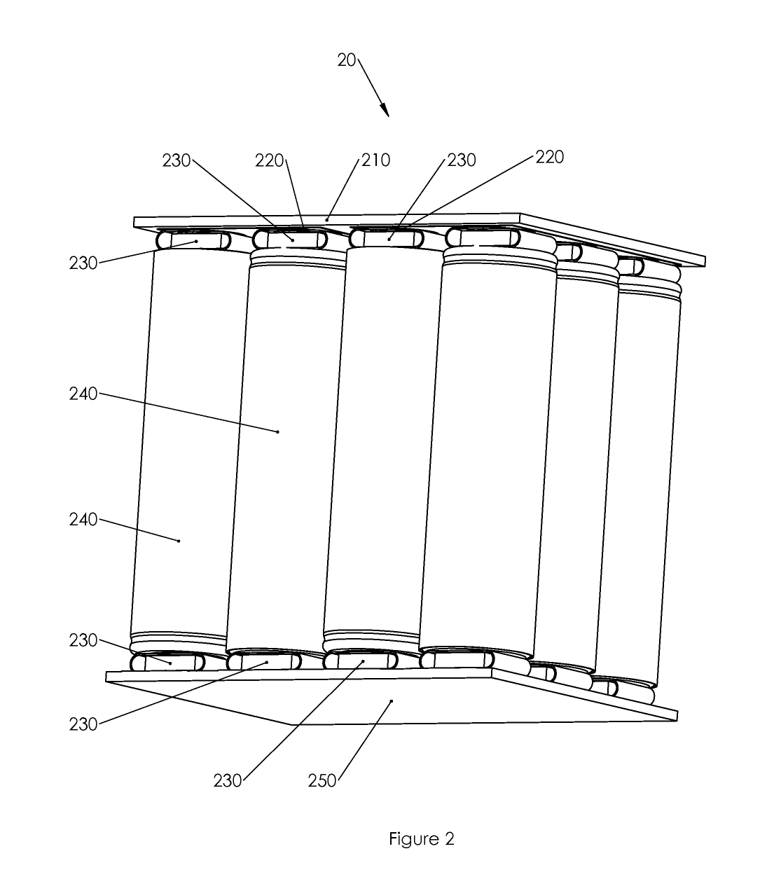

With reference to FIG. 2, an assembly 20 of multiple battery cells 240 positioned between a first PCB 210 and a second PCB 250, connected to the PCBs by way of tabs 220 may be seen. Note that the tabs 220 may comprise a spring element (such as an elastomeric pad, as discussed above). High conductivity battery contacts or tabs 220 can be used repeatedly on both ends to form a larger battery module. In this embodiment, the battery contact tabs 220 are used on both charged ends of each cylindrical battery cell. There are PCBs 210, 250 on opposite ends capping the assemblies. These PCBs 210, 250 may have current carrying pathways connecting adjacent cells in one of two patterns: series connection and parallel connection.

Another variation of a battery module has one high conductivity contact on one end of each cell. The other end of the cell can be electrically contacted in numerous traditional ways. Similarly, battery cells may be stacked in a line, and accordingly it is contemplated that the assemblies in accordance with some embodiments of the present invention may comprise two layers of cells with high current battery contacts capping each end.

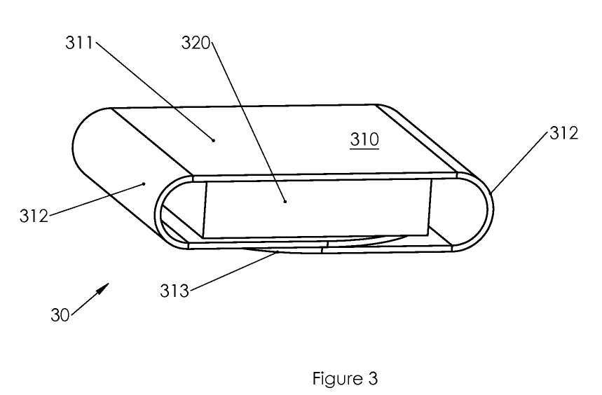

With reference to FIG. 3 shows, a tab and pad subassembly 30 will be discussed. The tab 310 may comprise three portions: a tab mounting section 311 that may be connected to a PCB, one or more flexible intermediate section 312 that may be flexible, and a contact section 313 that may make electrical contact with a battery cell. Note that as shown in FIG. 3, the tab mounting section 311 connected to the PCB is in the middle portion of the metal strip from which the tab 310 is formed. It is also contemplated that the middle portion of the metal strip from which the tab 310 is formed may be at any location on the assembly.

On the tab 30, the tab flexible intermediate section 312 may be a flexible section that may allow small movement of the tab 30. It may be located between the tab mounting section 311 and the tab contact section 313. The flexible section 312 may comprise a curved section of sufficient radius to allow for flexing without binding. The tab contact section 313 may comprise a flat area so as to make substantial contact with the typically flat contact end of a cylindrical battery cell. The ends may be trimmed to present a rounded end shape to the battery contact since the typical battery contact is itself rounded and thus excess material is avoided. However, any number of unrounded, faceted or freeform shapes would also function.

The tab 310 may provide electrical communication or conductivity between a battery cell and a PCB. The tab 310 must be in contact with the PCB, and it is contemplated may be—in accordance with some embodiments—attached to the PCB. For example, the tab 310 may be soldered or welded to a current carrying pathway on the PCB. Alternatively, the tab may be conductively adhered, or may use an additional structure that registers on the battery cell or PCB. Electrical connection from the tab to both the PCB and battery cell may be accomplished by the contact force generated by the compression of the elastomeric pad. Methods such as soldering, welding or adhesive add mechanical location of the tab and possible redundant electrical connection.

On a typical PCB the current carrying pathway or trace may be bonded to the dielectric substrate and therefore the tab 310 may be indirectly mechanically held in position relative to the PCB.

However, the process of soldering or welding the tab 310 to the PCB may be difficult. Since the tab 310 may be formed from a thin metal, when heated the tab 310 may warp or distort. Such distortions or warping may prevent a solid connection between the tab 310 and the PCB, or may cause the contact 313 of the tab 310 to become misaligned such that proper contact with a battery cell may be difficult.

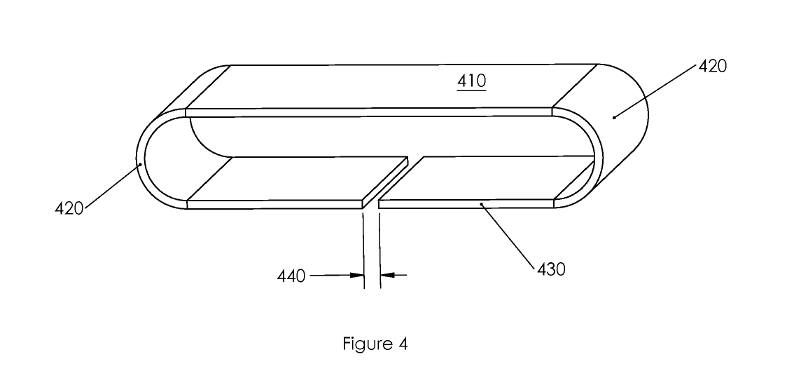

Accordingly, various shapes, sizes, and configurations of the tab 310 may be utilized to prevent, minimize, or otherwise control any distortion or warping. For example, with reference to FIG. 4, a tab 40 may be seen in which the oval or racetrack shape cross section of the tab 40 is not connected. The tab 40 may comprise a mounting portion 410, one or more flexible portions 420, and a contact portion 430. The contact portion 430 may be made by wrapping the two ends of the strip of metal from which the tab 40 was made around, but not bringing the ends together or overlapping, but rather leaving a small gap or closed gap with ends contacting 440. Small gap or closed gap with ends contacting 440 may provide sufficient room for expansion of the tab 40 during a soldering or welding process such that the tab 40 does not overly distort or warp.

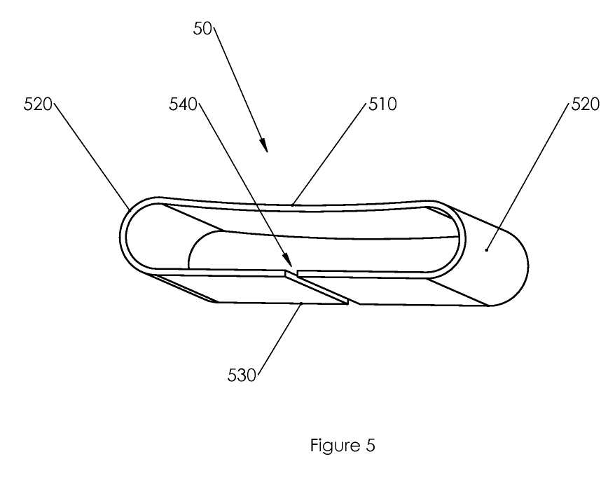

Similarly, with reference to FIG. 5, a tab 50 may again comprise a mounting portion 510 that is in contact with a PCB, one or more flexible portions 520, and a contact portion 530, which again may comprise a small gap or closed gap with ends contacting 540. With reference to FIG. 5, the contact portion 510 may be configured with a concave curvature. The concave curvature of the contact portion 510 may again assist in minimizing any distortions or warping that may be caused by a soldering or welding process. The concave curvature may be advantageous over a convex curvature for at least two reasons. First, a convex curvature may make alignment of the tab 50 to the PCB prior to attachment difficult, as the tab 50 may be fee to rock on the curve. Therefore, the tab 50 may be attached the PCB on an angle, potentially resulting in inadequate or undesirable contacts between the tab 50 and the PCB and/or the tab 50 and a battery cell.

Second, a convex curvature—unless fully flattened out during attachment to the PCB, may present a longer current path. Longer current paths may be undesirable for any number of reasons.

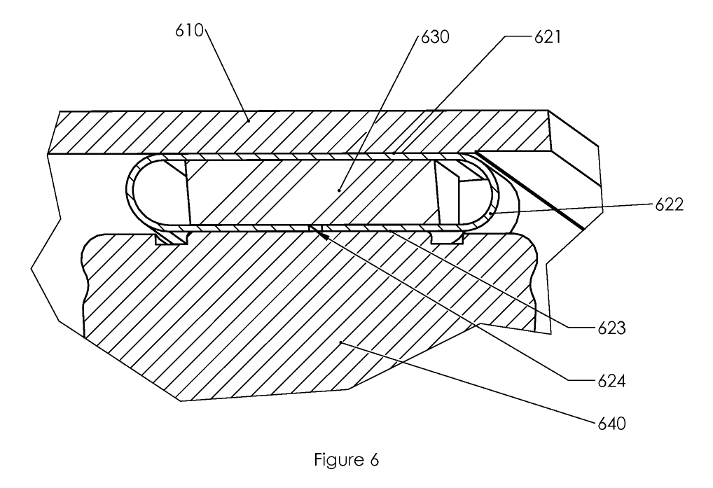

With reference to FIG. 6, an assembly 60 of a PCB 610, tab 620, elastomeric pad (or spring element) 630, and a battery cell 640 will now be discussed. Tab 620 may comprise a mounting section 621 that connects the tab 620 to the PCB 610. Tab 620 may further comprise one or more flexible sections 622, and a contact section 623 that may contact the batter cell 640. The contact section 623 may be formed from the two ends of the strip of metal from which the tab is formed with a small gap or closed gap with ends contacting 624 there-between. Assembly 60 may further comprise an elastomeric pad (or spring element) 630 disposed within the tab 620.

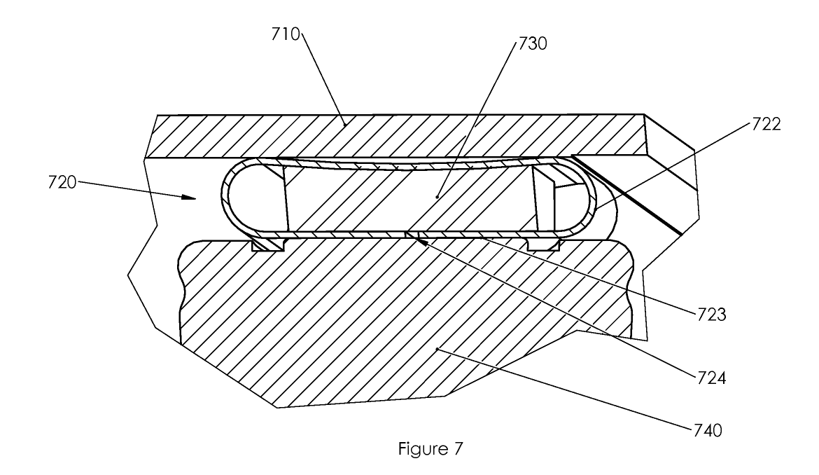

With reference to FIG. 7 an assembly 70 of a PCB 710, tab 720, elastomeric pad (or spring element) 730, and a battery cell 740 will now be discussed. As above, tab 720 may comprise a mounting section 721 that connects the tab 720 to the PCB 710. Note that mounting section 621 may be formed with a convex curvature. Tab 720 may further comprise one or more flexible sections 722, and a contact section 723 that may contact the batter cell 740. The contact section 723 may be formed from the two ends of the strip of metal from which the tab is formed with a small gap or closed gap with ends contacting 724 there-between. Assembly 70 may further comprise an elastomeric pad (or spring element) 730 disposed within the tab 720.

Operation.

The electrical current carrying capacity of the high conductivity battery contact may be greater than traditional battery contact assemblies. Traditional battery contact assemblies generally utilize steel coil springs or steel leaf spring contacts. Although electrically they are very different, the high conductivity battery contact operates mechanically in a similar manor to traditional battery contact assemblies.

The physical operation of the high conductivity battery contact may be similar to traditional low conductivity battery contact assemblies. A battery cell may be held in close proximity to a PCB so as to exert a contact pressure on the tab contact surface. This contact force in turn may compress the pad so as to consistently apply pressure contact between the battery cell and the tab contact. The pad pressure may be created by being sandwiched on the other side by direct or indirect pressure from the circuit board. A tab made from thin soft metal may not have sufficient structural stiffness to provide reliable contact pressure on its own.

If both ends of the battery cell utilize high conductivity battery contacts, then each of the battery cells may be compressed between mirrored high conductivity battery contact assemblies. In this case the PCBs may need to be held in position by an external wall structure and possibly by spacers between PCBs. Such spacers may be slightly longer than the battery cells and a length sufficient to allow moderate compression of the elastomeric pads. It is contemplated that for larger battery assemblies, multiple spacers may be required to maintain the structural integrity of the PCBs.

The PCB may provide structural support for the cylindrical battery cells to keep the cells parallel with end surfaces in the same plane. Given the significant weight of a typical battery cell, a PCB supporting one or more battery cells may requires strength and rigidity.

Servicing of a pack using high conductivity battery contacts may be greatly simplified. When the PCB is lifted away from the cells, all of the contact assemblies are removed with it allowing for a modular assembly with few to no loose parts or wires.

The ability of the tab to flex and accommodate slight variation in cell length may be advantageous. For example, during shock or vibration the flexible characteristics of the tabs may maintain electrical contact. Such contact may be assisted through the use of elastomeric pads or compressive springs, since such elements may provide a constant force on the tab pushing it into contact with the batter cell.

In accordance with embodiments of the present invention the tab may be positioned such that the side that has overlapping ends (or a gap where the ends fail to overlap, as seen in FIGS. 4 and 5) may be oriented to be on the side adjacent to the PCB.

In accordance with some embodiments of the present invention, tabs may be configured to have two, three, four or any number of tab contact sections. Each tab contact sections may be connected to a tab mounting section by a flexible section. The shape of the flexible section may also vary. A single bend is one possibility, but a sharp bend or a series of bends may also provide equivalent functionality.

It will be understood that the specific embodiments of the present invention shown and described herein are exemplary only. Numerous variations, changes, substitutions and equivalents will now occur to those skilled in the art without departing from the spirit and scope of the invention. For example, the contact sections of the tab may be configured to specifically match or align with a contact cross section of a batter cell. Similarly, the specific shapes shown in the appended figures and discussed above may be varied without deviating from the functionality claimed in the present invention. Accordingly, it is intended that all subject matter described herein and shown in the accompanying drawings be regarded as illustrative only, and not in a limiting sense, and that the scope of the invention will be solely determined by the appended claims.

I claim:

1. A battery contact for providing electrical contact between one or more battery cells and a printed circuit board, the battery contact comprising:
a tab made at least in part from an electrically conductive material, comprising:
a mounting section configured to provide an electrical connection to the printed circuit board;
at least one flexible section; and
a contact section having an outward facing surface; and
a compressive spring configured to push the contact section away from the mounting section, and against an end of a cylindrical battery cell when installed.

2. The battery contact of claim 1, wherein the mounting section is configured to be mechanically attached to the printed circuit board.

3. The battery contact of claim 1, wherein the mounting section is configured with a convex curvature away from the printed circuit board.

4. The battery contact of claim 3, wherein the electrically conductive material is a strip having two ends, and wherein the contact section comprises the two ends of the strip with a small gap or closed gap with ends contacting there-between.

5. The battery contact of claim 1, wherein the electrically conducive material is a strip having two ends.

6. The battery contact of claim 5, wherein the contact section comprises the two ends of the strip with a small gap or closed gap with ends contacting there-between.

7. The battery contact of claim 1, wherein the contact is configured to reduce distortion or warping during a soldering or welding process.

8. The battery contact of claim 1, wherein the electrically conductive material is selected from the group consisting of: copper, gold, silver or aluminum.

9. The battery contact of claim 1, wherein the compressive spring comprises an elastomeric material.

10. The battery contact of claim 9, wherein the elastomeric material comprises silicone or silicone foam.

11. A battery contact for providing electrical contact between one or more battery cells and a printed circuit board, the battery contact comprising:
a tab made at least in part from a strip of an electrically conductive material the strip having two ends, comprising:
a mounting section configured with a convex curvature away from the printed circuit board, and to provide an electrical connection to the printed circuit board;
at least one flexible section; and
a contact section comprising the two ends of the strip of material with a small gap or closed gap with ends contacting there-between; and
a compressive element disposed between the contact section and the mounting section, the compressive element configured to force the contact section into electrical communication with an end of a battery cell.

12. The battery contact of claim 11, wherein the electrically conductive material is selected from the group consisting of: copper, gold, silver or aluminum.

13. The battery contact of claim 11, wherein the tab has a thickness of 0.001 inches to 0.010 inches.

14. The battery contact of claim 11, wherein the compressive element comprises an elastomeric material.

15. The battery contact of claim 14, wherein the elastomeric material comprises silicone or silicone foam.

16. The battery contact of claim 9, wherein the tab is electrically and mechanically connected to the printed circuit board by soldering or welding.

17. The battery contact of claim 11, wherein the contact is configured to reduce distortion or warping during a soldering or welding process.
